(19) United States
(12) Patent Application Publication
(10) Pub. No.: US 2022/0295834 A1
(43) Pub. Date: Sep. 22, 2022

(54) Method of Restoring and Maintaining the Texture of Tapioca Pearls as Just Cooked after Retrogradation

(71) Applicant: Sheng Yao, Longwood, FL (US)

(72) Inventor: Sheng Yao, Longwood, FL (US)

(73) Assignee: Sheng Yao, Longwood, FL (US)

(21) Appl. No.: 17/207,723

(22) Filed: Mar. 21, 2021

(51) Int. Cl. A23L 3/375; A23L 29/219; A23L 29/262; A23L 29/269

(52) U.S. Cl. CPC A23L 3/375; A23L 29/219; A23L 29/262; A23L 29/273

(57) ABSTRACT

The present invention relates to a method of storing and transporting cooked tapioca pearls in edible oil at low temperature (0° F. to 41° F.). Even though retrogradation happens under these conditions, the texture of tapioca pearls can be restored like just cooked by reheating in the oil to above starch gel temperature. The restored texture of tapioca pearls can be kept unchanged as long as the temperature is above their gel temperature.

### BACKGROUND OF THE INVENTION

### Field of Invention

The present invention relates to a method of restoring and maintaining texture of tapioca pearls as just cooked after retrogradation happened during long period of storage at low temperature (0° F. to 41° F.).

### Description of the Prior Arts

Tapioca pearls used in beverages, such as boba tea, are difficult to store and distribute after being cooked. Distribution needs the products to be stored at low temperatures, typically below 41° F. or for longer period at 0° F. As a starch based product, retrogradation occurs quickly at these temperatures and the tapioca pearls lose their softness and chewiness. Therefore, in boba tea stores, the raw tapioca pearls have to be cooked on-site. A typical procedure is that the tapioca pearls are cooked in boiling water for 5 to 30 minutes (depending on if chemically modified starch is used), then they are immersed in hot water for 20 to 30 minutes so as to fully cook the tapioca pearls. Thereafter, the cooked tapioca pearls are rinsed with water, drained and then soaked with sugar syrup. Due to retrogradation, the texture of these tapioca pearls can only be kept for 2-4 hours at room temperature or even shorter in refrigerator. Therefore, the practice in this business is keeping the cooked tapioca pearls at a temperature above the gel temperature in a sugar syrup. While this approach eliminated the possibility of gel retrogradation, the gel at this temperature gradually absorbs the water and start to swell. At the first couple of hours, the swell may be unnoticeable. But eventually, the increase of the water content thins the gel and change the texture unfavorably (too soft). Also, when these tapioca pearls are in contact each other, they likely stick together and eventually make them very difficult to separate, so they need to be stirred from time to time.

For business use, it is preferred that the tapioca pearls are cooked in a centralized facility and the storefront can use them right way. One effort to do so can be found in U.S. Pat. No. 6,455,091. It mentions a method of freezing the tapioca pearls immediately after they are cooked. When this is done quick enough, the polymer chains have no time to reorganize and crystallize/harden, which allows the texture to be unchanged. The frozen product can be stored and transported at 0° F. in a long period. The frozen tapioca pearls are reheated preferably by microwave to above the gel temperature just before being consumed to avoid the change of texture afterwards. The inconvenient part of this method is that it involves a several minutes of reheating process every time a customer comes in. This may be the main reason this method is not widely adopted in real businesses.

Another example is mentioned in the CN104905086A, tapioca pearls composed of tapioca starch, chemical modified starch, caramel color, polysaccharide, maltose and maltose amylase are made for long term storage stability at around 40° F. after being cooked. Locally, a large portion of the native tapioca starch has been substituted by modified starch, especially crosslinked starches, which the polymer chains are covalently linked with a bridge. The bridge, acting as a spacer, greatly reduces the possibility of polymer chains approaching each other, hence the recrystallization of the gel. Also, adding hydrocolloids, such as gums, decreases the tendency of the retrogradation. Addition of sugar enzyme can reduce the length of the starch polymer chains and short chains mean less intermolecular interaction, consequently less tendency of retrogradation. Combining all these factors, the resulted gel realizes great retrogradation retardation, but the tapioca pearls are only pre-cooked for 30-45 seconds before storage and transportation. It suggests that the tapioca pearls need to be fully cooked before use. No mention of how long the pearls can keep the texture after being cooked. Also, the starch chemical modification process is not environmentally friendly and increases the investment on infrastructure and cost of operation.

Other documented research efforts are focused in trying to change the gel structure to prevent or retard the gel retrogradation at low temperature, hence eliminating the reheating process before use. An example is found in JP6340514B2, a tapioca pearl recipe with improved retrogradation is provided, which is made of chemically modified tapioca starch, kanjac gum and a starch swelling inhibiting polysaccharide or/and collagen peptide. Again, strictly speaking, these are not tapioca pearls anymore as no native tapioca starch is used. Although the tapioca pearls in the example claim good sensor results after up to 14 day stored between 32-40° F., they still observe significant swelling of the pearls. Using the same approach, some so called tapioca pearls using chemically modified starch on the market achieve softness for weeks or months at 0° F. or 32-40° F. to room temperature, such as those in Imei Brown Sugar Boba Ice Cream Bars. But it is still impossible to preserve the texture of cooked tapioca pearls made with native tapioca starch.

Last related invention is found in U.S. Pat. No. 4,690,829, that invention relates to a method of preventing the retrogradation of foodstuffs containing starchy material in general, wherein waxy barley starch is used as part of the starchy material. Optionally, a polysaccharide is added to the starchy material. Here instead of using chemically modified starch, a native waxy barley starch is found very effective on retarding the retrogradation of normal starch gel, but no mention of how to apply this observation to tapioca pearls businesses is found and this starch is rare and not easy to find.

### SUMMARY OF THE INVENTION

Here this invention presents a new approach by allowing the retrogradation to occur at refrigerator or freezer temperature during the storage and distribution period. Before being used, they are brought back to the original texture resembling as if they had just been cooked. Our research found that this object could be realized by reheating the tapioca pearls in a hydrophobic media, such as most edible oils. Also, our research indicates that the texture can be kept unchanged in these oils as long as temperature is above gel temperature. Our results also showed that this method is effective not only to native starch tapioca pearls but also to ones made with chemically modified starches. Thus, these tapioca pearls can be served immediately in retail store, which is a big advantage comparing to commonly used method.

### DETAILED DESCRIPTION OF THE INVENTION

For boba tea businesses, emphasizing the cooking of tapioca pearls can improve the efficiency, reduce the cost, and simplify the retail operation. However, no widely accepted ready to serve cooked tapioca pearls are available. This invention develops a method that is suitable for preparing, cooking and storing tapioca pearls in a centralized facility and ready for use in retail stores with a simple procedure. In this method, the cooked tapioca pearls are cooled and stored at 0° F. or 32-40° F. The cooked tapioca pearls may be dispersed in oil before or after being cooled down or frozen. The product will be stored and transported at these temperatures. Retrogradation happens during these procedures, but our method of reheating them in oil to above gel temperature can effectively restore their texture with no difference as just after they have been cooked. As long as the product is kept above the gel temperature, it will not show any sign of retrogradation or swelling. Traditionally, when the tapioca pearls are kept in sugar syrups, as a starch gel, it will absorb more water and the tapioca pearls will swell. This swelling accelerates at high temperature. For not long, the tapioca pearls swell and become too soft. In this invention, we find that replacing the aqueous sugar solution with an edible oil, the swell disappeared, and the cooked tapioca pearls can keep the softness and chewiness as long as the temperature is above gel temperature. In this period, the cooked tapioca pearls can be used right away, thus simplify the operation. An additional benefit of using the method mentioned in this invention is the tapioca pearls will not stick together easily due to existing of a thin oil film between them and can be easily separated in contrast to those being kept in aqueous sugar solutions.

The edible oils mentioned here include any vegetable base oil or the mixture of them, such as normal vegetable oil, canola oil, corn oil, sunflower oil, salad oil, olive oil, coconut oil, almond oil, soy bean oil, to name a few or animal-based oil, such as butter, animal fat oil,

This method can be applied to tapioca pearls used in any beverages, although only boba tea is mentioned here. The tapioca pearls may be made from native starch, chemically modified starch, including crosslinked starch with or without additives, such as hydrocolloids, emulsifier and stabilizer, enzymes, caramel color, brown sugar, sugar syrup, to name a few.

### EXAMPLE 1

Tapioca pearls made of native tapioca starch were cooked in boiling water for 30 minutes and kept at 140-211° F., preferably at 150-170° F. for 30 min. Then were rinsed with cold water. The excess water was drained and the tapioca pearls were poured into a container filled with vegetable oil, which was then kept in a refrigerator or a freezer. Before use, the tapioca pearls in oil were reheated to 140-211° F., preferably 150-170° F. to bring the temperature of the tapioca pearls above their gel temperature and then kept at this temperature before being consumed. When serving, the oil was drained while the other ingredients were prepared. Then the tapioca pearls were lightly rinsed with water to remove the oil residue and added to the beverage.

### EXAMPLE 2

Commercially available tapioca pearls made with a mixture of native and modified starch (for example, E-Fa Brand black tapioca pearl), were boiled in water for 5-10 minutes and then kept at 140-211° F., preferably at 150-170° F. for 15-30 minutes, rinsed with water and stored in vegetable oil after draining the water. The tapioca pearls in oil were stored in a freezer. The frozen tapioca pearls were then reheated to 140-211° F., preferably 150-170° F. for 30-60 min, preferably 45-60 min to bring the tapioca pearls above gel temperature and kept at this temperature before serving. When an order comes in, measure one cup of tapioca pearls and drain the oil when preparing other ingredients. The tapioca pearls were rinsed by water to remove the oil residue before adding to the drink mixture. The tapioca pearls kept in oil at 150-170° F. has no detectable change on texture or swelling for at least three days.

### EXAMPLE 3

The above-mentioned tapioca pearls were cooked, cooled and frozen immediately. They were then mixed with shorting oil and transported to the storefront. Before use, they were heated to above gel temperature and kept at this temp before served. No observable change of texture of the tapioca pearls were found for at least three days.

1. A method of storing and transporting cooked tapioca pearls in oil at low temperature for a long period (0° F. for up to a year or 32-40° F. for up to seven days) even though retrogradation happens under these conditions. And the subsequent restoration of the tapioca pearls texture to be like just cooked by reheating the retrograded tapioca pearls in the oil to above starch gel temperature (between 150° F. and 211° F., preferably between 150-170° F. The restored texture of tapioca pearls can be kept unchanged as long as the temperature is above their gel temperature.

2. The method of claim 1, wherein said the edible oil includes but not limited to vegetable oil, canola oil, corn oil, sunflower oil, salad oil, olive oil, coconut oil, almond oil, soy bean oil or animal-based oil, such as butter, animal fat oil etc.

3. The method of claim 1, wherein said the edible tapioca pearls (tapioca pearls) are made of native starch or chemically modified starch with or without additives. Native starches include but not limited to tapioca starch, potato starch, corn starch, taro starch, rice starch, waxy rice starch, waxy corn starch, waxy barley starch etc. Chemically modified starches include but not limited to those with E numbers from E1400-E1450. The additives include polysaccharide, caramel color, brown sugar, emulsifier, stabilizer and preservers. The polysaccharides include but not limited to an oligosaccharide, dextrin, carrageenin, pectin, locust bean gum, guar gum, tamarind tum and xanthane gum. Emulsifiers and stabilizers include but not limited to those with E number from E400-E499. The preservatives include but not limited to those with E number from E200-E299.
